(19) United States
(12) Patent Application Publication
(10) Pub. No.: US 2025/0021659 A1
(43) Pub. Date: Jan. 16, 2025

(54) SECURITY VULNERABILITY CONSTRAINTS FOR MACHINE LEARNING SYSTEMS

(71) Applicant: International Business Machines Corporation, Armonk, NY (US)

(72) Inventors: Lukasz G. Cmielowski, Kraków (PL); Daniel Jakub Ryszka, Kraków (PL); Dorota Laczak, Mielec (PL); Szymon Kucharczyk, Cracow (PL)

(21) Appl. No.: 18/455,661

(22) Filed: Aug. 25, 2023

(30) Foreign Application Priority Data
Jul. 12, 2023 (GB) 2310654.5

(51) Int. Cl. G06F 21/57

(52) U.S. Cl. CPC G06F 21/577

(57) ABSTRACT

Disclosed herein is a computer implemented method for generating a machine learning system from software packages. The software packages comprise package specific security vulnerability metadata. The method comprises receiving a specification of the machine learning system, wherein the specification comprises security vulnerability constraints. The method further comprises selecting the software packages from a collection of software packages using the specification and by comparing the package specific security vulnerability metadata to the security vulnerability constraints. The method further comprises generating the machine learning system using the selected software packages. The method further comprises training the machine learning system using the specification.

### BACKGROUND

The present invention relates to machine learning.

A machine learning system may be generated using a variety of different software packages such as: machine learning models, run time environments, executable binaries, and executable scripts. The different software packages may each have their own security vulnerabilities.

### SUMMARY

In one aspect the invention provides for a computer-implemented method for generating a machine learning system from software packages. The software packages comprise package-specific security vulnerability metadata.

The method comprises receiving a specification of the machine learning system. The specification comprises security vulnerability constraints. The method further comprises selecting the software package from the selection of software packages using the specification and by comparing these package-specific security vulnerability metadata to the security vulnerability constraints. The method further comprises generating the machine learning system using the selected software packages. This may include constructing the machine learning system from the selected machine learning models as well as selecting the binaries or runtime components of the machine learning system. The method further comprises training the machine learning system using the specification.

According to a further aspect of the present invention, the invention provides for a computer program product that comprises a computer-readable storage medium having computer-readable program code embodied therewith. The computer-readable program code is configured to implement an embodiment of the method.

According to a further aspect of the present invention, the invention provides for a computer system that comprises a processor configured for controlling the computer system. The computer system further comprises a memory storing machine-executable instructions. The execution of said instructions causes the processor to receive a specification of a machine learning system. The specification comprises security vulnerability constraints. The execution of said instructions further causes the processor to select software packages from a collection of software packages. The software packages comprise package-specific security vulnerability metadata. The software packages are selected using the specification and by comparing the package-specific security vulnerability metadata to the security vulnerability constraints. The execution of said instructions further causes the processor to generate the machine learning system using the selected software packages. The execution of said instructions further causes said processor to train the machine learning system using the specification.

### BRIEF DESCRIPTION OF THE DRAWINGS

In the following embodiments of the invention are explained in greater detail, by way of example only, making reference to the drawings in which:

FIG. 1 illustrates an example of a computing environment.

FIG. 2 shows a further view of the computing environment of FIG. 1.

FIG. 3 shows a flow chart which illustrates a method of operating the computing environment of FIG. 1 or 2.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The security of Artificial Intelligence (AI) and machine learning systems (200) is a hot topic today. Many researchers and companies are focusing on model resistance to adversarial attacks. However, keeping models alive on production system requires tracking the vulnerabilities in used packages. The security vulnerabilities (patches) are delivered frequently on different schedule by many vendors (each python package goes with its own release cycle)—managing that is not trivial. Informing the customer about a vulnerability in its AI and providing the mitigation techniques is very costly, time-consuming, and breaking production systems. Manual updating of all deployed pipelines, due to security fixes, is time consuming and erroneous without domain-specific knowledge. The automated AI building systems are not yet adjusted to handle such security aspects during model training, described herein as a production readiness level.

Examples may be beneficial because the selection of the software packages by using both the specification and by comparing the package specific security vulnerability metadata to the security vulnerability constraints may provide for a machine learning system which has an effective tradeoff between security and functionality of the machine learning system.

A Security vulnerability may encompass a weakness in an information system, system security procedures, internal controls, or implementation that could be exploited or triggered by a threat source. Package specific security vulnerability metadata may be data which may be descriptive of these security vulnerabilities.

In some examples, the package-specific security vulnerability metadata may comprise data which provides a ranking of how secure a particular software package is and/or lists a number of known vulnerabilities and/or specific security vulnerabilities for the software components used to construct that software package.

For example, the below file lists specific vulnerabilities for python3:

```
[
  {
    ″notice″: ″https://access.redhat.com/errata/RHSA-2022:6457″,
    ″notice_exempt″: false,
    ″notice_id″: ″RHSA-2022:6457″,
    ″summary″: ″Python is an interpreted, interactive, object-oriented
  programming language, which includes modules, classes, exceptions, very high
  level dynamic data types and dynamic typing. Python supports interfaces to
  many system calls and libraries, as well as to various windowing systems.
  \nSecurity Fix(es):\n* python(mailcap): findmatch( ) function does not sanitise
  the second argument (CVE-2015-20107)\n* python: urllib.parse does not
  sanitize URLs containing ASCII newline and tabs (CVE-2022-0391)\nFor more
  details about the security issue(s), including the impact, a CVSS score,
  acknowledgments, and other related information, refer to the CVE page(s) listed
  in the References section.″,
    ″vulnerable_packages″: [
  {
    ″corrective_action″: ″Upgrade python3-libs to >= 3.6.8-47.e18_6″,
    ″description″: ″python3-libs has vulnerabilities″,
    ″fix_version″: ″3.6.8-47.el8_6″,
    ″installed_version″: ″3.6.8-45.e18″,
    ″package_name″: ″python3-libs″
  },
  {
    ″corrective_action″: ″Upgrade platform-python to >= 3.6.8-47.el8_6″,
    ″description″: ″platform-python has vulnerabilities″,
    ″fix_version″: ″3.6.8-47.e18_6″,
    ″installed_version″: ″3.6.8-45.e18″.
    ″package_name″: ″platform-python″
  }
]
}
```

The data for such files, as shown above, can be used to extract package specific vulnerability data. In this above example, details about upgrading platform-python and python3-libs are provided.

The package-specific security vulnerability metadata may comprise different metadata fields. Some exemplary metadata fields are:

A software specification link (for example an ID of the software package) which enables getting a list of dependencies for this model. This may include a package name, version, etc. The metadata may also include a package specific security vulnerability score. The metadata may also include a threshold for a calculated difference between the projected security compliance metric and the current security compliance metric. This threshold may be a threshold used to decide when to install a software patch.

A security vulnerability constraint may include constraints which need to be satisfied by the machine learning system. This, for example, could provide minimum security ratings or levels as specified in the specific security vulnerability metadata.

The specification of the machine learning system may include such things as the architecture of the machine learning system including the input or data that is input into the machine learning system as well as the type of data that is output by the machine learning system. The specification of the machine learning system may also provide the training data used for training the machine learning system.

A software package, as used herein, may encompass software or executable code used in constructing or implementing the machine learning system. This may include such things as machine learning models, as well as the time or executables, used for implementing these machine learning models.

The training of the machine learning system using the specification may include using training data which is a part of the specification of the machine learning system.

In another example the method further comprises calculating a current security compliance metric of the machine learning system from the package-specific security vulnerability metadata of the selected software packages. The current security compliance metric may be a numerical value or score which is assigned to the security level of the machine learning system. The current security compliance metric may, for example, be calculated using data taken from the package-specific security vulnerability metadata. This example may be beneficial because it may provide for a means of rating the security of the machine learning system based on its individual components.

In another example the package-specific security vulnerability metadata comprises a package-specific security vulnerability score and a package-specific security penalty score. The current security compliance metric of the machine learning system is a sum of the package-specific security vulnerability score multiplied by the package-specific security penalty score sum for the selected software packages. The calculation of the package-specific security vulnerability score may be beneficial because it may provide for a means of rating the security of the machine learning system in an objective fashion based on the software packages from which it is constructed.

In another example the method further comprises receiving a security patch for one of the software packages. The method further comprises calculating a projected security compliance metric. The method further comprises providing a signal that the difference between the projected security compliance metric and the current security compliance metric is below a predetermined threshold. The providing of this signal may be beneficial because it may be used as a means to decide if a security patch should be implemented or not.

In another example the signal causes the providing of a warning signal. This may, for example, be useful for alerting an administrator or operator of the machine learning system.

In another example the signal causes the providing of a notification.

In another example the signal causes the blocking of the security patch. This may, for example, be useful because it may provide a means of automatically skipping a security patch if it does not provide enough of a benefit.

In another example the method further comprises installing the security patch if the difference between the projected security compliance metric and the current security compliance metric is above the predetermined threshold. This example may be beneficial because it may provide for automatic approval of a security patch.

In another example the method further comprises receiving an updated software package. The software packages comprise the updated software package. The method further comprises integrating the updated software package into the machine learning system. The method further comprises retraining the machine learning system after integration of the updated software package. The method further comprises outlaying the current security compliance metric of the machine learning system.

In another example the software packages further comprise at least one machine learning metric. A machine learning metric as used herein may be a metric, score, or value which is used to evaluate the functionality of the machine learning system. For example, the machine learning metric may be used to rate how precise or accurate a machine learning system is at providing a prediction. The method further comprises constructing an objective function from the at least machine learning metric and the current security compliance metric. The training of the machine learning system comprises optimizing the objective function.

This example may be beneficial because, normally, the objective function will be based purely on the at least one machine learning metric. For example, there may be a loss function in a deep learning algorithm which is used to train the machine learning system. When making the objective function dependent upon both the machine learning metric and the current security compliance metric, both the security and the accuracy of the machine learning system may be improved.

In another example the objective function is a difference between at least one machine learning metric and the current security compliance metric.

In another example the method further comprises determining the package-specific security vulnerability metadata using a security vulnerability scan module. The security vulnerability scan module may for instance be a software tool or executable, which is programmed to probe the various software packages automatically for security vulnerabilities. This example may be beneficial because it may provide for an automated and objective means of determining at least a portion of the package-specific security vulnerability metadata.

In another example the specification of the machine learning system further comprises training data.

In another example the specification of the machine learning system further comprises an input specification of the machine learning system. The input specification may for example be the data which is input into the machine learning system.

In another example the specification of the machine learning system further comprises the output specification of the machine learning system. This would then be the data or the format of the data that is output by the machine learning system.

In another example selecting the software packages from the collection of software packages using the specification and by comparing the package-specific security vulnerability metadata to the security vulnerability constraints is a filtering process. Various filtering definitions may be applied to disqualify particular software packages.

In another example the security vulnerability constraint comprises a severity of allowed security vulnerabilities.

In another example the security vulnerability constraints comprise a number of vulnerabilities.

In another example the software packages comprise an artificial intelligence model.

In another example the software packages comprise an estimator model.

In another example the software packages comprise a predictor model.

In another example the software packages comprise an executable file.

In another example the software packages comprise an executable script.

In another example the software packages comprise a binary file.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a machine learning system 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

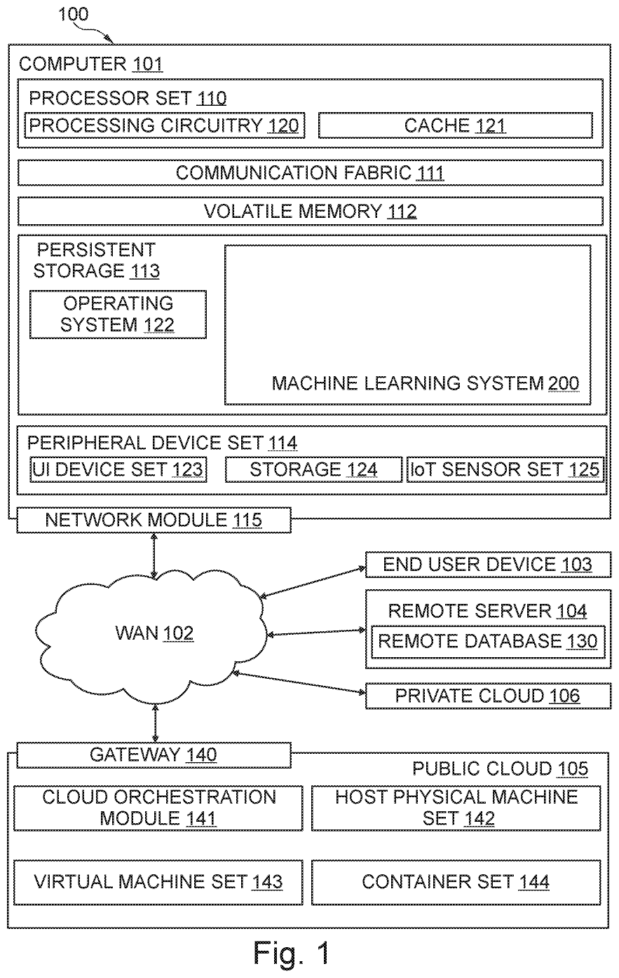

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

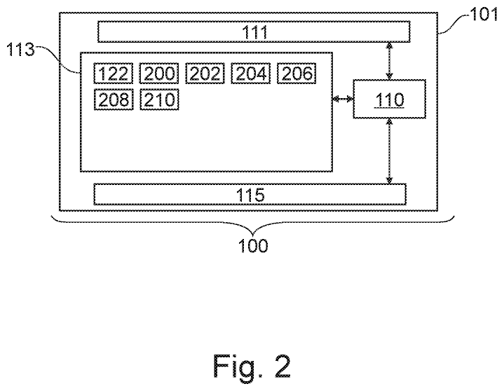

FIG. 2 illustrates a further example of the computing environment 100. Not all features present in the illustration of FIG. 1 are shown in FIG. 2. The persistent storage 113 is shown as containing the operating system 122 and the machine learning system 200. Additionally, the persistent storage 113 is further shown as containing a collection of software packages 202. The software packages 202 may comprise different packages such as artificial intelligence models, executable binaries, scripts and other software which may be used to construct the machine learning system 200.

The memory 113 is further shown as containing a specification of the machine learning system 206. This contains such details as the type and format of the data that is input into the machine learning system 200 as well as the format and data type of data that is provided by the machine learning system 200. The specification of the machine learning system 206 may also comprise training data for training the machine learning system 200. The persistent storage 113 may further comprise a set of security vulnerability constraints 208. The persistent storage 113 is also shown as containing package-specific security vulnerability metadata 204. This may contain data about the specific security vulnerabilities of individual software packages 202. The security vulnerability constraints 208 may use the package-specific security vulnerability metadata 204 and/or the specification of the machine learning system 206 to select the selected software packages 210 from the software packages 202.

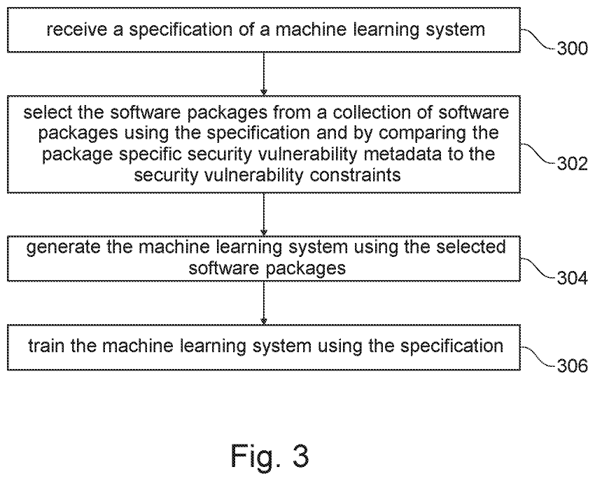

FIG. 3 shows a flowchart which illustrates a method of operating the computing environment 100. In step 300, a process receives the specification of the machine learning system 206. In step 302 the process selects the software packages 210 from a collection of software packages 202 using the specification 206 and by comparing the package-specific security vulnerability metadata 204 to the security vulnerability constraints 208. In step 304, the process generates the machine learning system 200 using the selected software packages 210. In step 306, the process trains the machine learning system 200 using the specification 206.

The user may define security vulnerability constraints 208 as part of the method described in FIG. 3. Exemplary security vulnerability constraints 208 may include one or more of the following: severity of allowed vulnerabilities; the number of vulnerabilities; combination of both the number of vulnerabilities and the severity of the vulnerabilities: allowed models can have MEDIUM and lower vulnerabilities only; a current security compliance metric based on a package specific penalty score; and a current security compliance metric definition which may be defined using vulnerability constraint and vulnerability scan results.

TABLE 1
Example of vulnerability constraints configuration:

| Constraint definition | Allow | Weight |
|---|---|---|
| Critical | FALSE | 0.5 |
| High | FALSE | 0.25 |
| Medium | TRUE | 0.15 |
| Low | TRUE | 0.05 |

The above table shows a sample configuration of vulnerabilities constraints. The list includes vulnerability severities and details if a particular constraint definition is allowed or not. This, for example, can be used to filter software packages to exclude them from the machine learning system. The weights correspond to severities and can be customized if needed. The values are scaled to be in the range (0, 1) to be compliant with machine learning scores like accuracy, precision, etc. An advantage of table 1 is that descriptive terms like “Critical” or “High” can be converted into objective constraints or provide a numerical weight or value.

TABLE 2
Security vulnerabilities exiting in packages used in a
training runtime of the machine learning system 200:

| | Security | Security | | |
|---|---|---|---|---|
| Software | vulnerability | vulnerability | | Penalty |
| specification | state | severity | Penalty | score |
| scikit-learn 0.24 | 0 | | FALSE | 0 |
| xgboost 1.6.2 | 1 | High | TRUE | 0.25 |
| lightGBM 3.3.2 | 0 | | FALSE | 0 |
| lale 0.7.1 | 0 | | FALSE | 0 |
| snapML 1.8.10 | 1 | Low | FALSE | 0 |

Table 2 shows a further example of package specific security vulnerability data. The Boolean penalty column is calculated by mapping a user's provided constrain configuration to security vulnerabilities severity (part of scan result mapped to training runtime packages).

Penalty=TRUE if security_vulnerabilities_state==1 AND Constrain_definition.allow is FALSE.

The package specific penalty score is calculated by applying the weight value from configuration matrix to the package available on training system with identified security vulnerability.

Penalty score=Constrain_definition.weight(from table1) if penalty=TRUE else0 (for corresponding severity of vulnerability).

Finally, a current security compliance metric may be calculated and used, for example, as part of an objective function to be optimized during training of the machine learning system. The objective function may be a difference between the machine learning metric and the current security compliance metric.

The machine learning metric (accuracy below) and the current security compliance metric (penalty score below) may also be used outside of an objective function to select different machine learning models. As an example, two different estimators (models) are compared: XGBClassifier and RandomForestClassifier.

XGBClassifier ml_score(accuracy)=0.89 penalty_score=0.25 vulnerability_optimisation_score=0.89−0.25=0.64. 1.

RandomForestClassifier ml_score(accuracy)=0.88 penalty_score=0 vulnerability_optimisation_score=0.88. 2.

Comparing 1 and 2 above, it can be seen that the RandomForestClassifier has a higher score and is subsequently selected over XGBClassifier. The machine learning system is essentially optimized by selecting RandomForestClassifier.

A current security compliance metric (the higher the better) may be used to answer the question: how many security vulnerabilities are there in packages my model is based on? What are the severities of them? The metric formula may be based on CVSS scores, which provides translation of qualitative to quantitative score (from LOW-MED-HIGH-CRIT to 0-10 range). The current security compliance metric may be a normalized (scaled to range (0,1)) and linear combinations of CVSS scores present in the software packages used to construct a machine learning model:

cvss_security_compliance_score=1−norm(sum(vuln_cvss_score\hat{ }w)), where w stands for weight(the higher weight the biggest impact of high severity vulnerabilities)

Note: the formula can be easily customized by adding additional weighting factors w₁ . . . wₙ per each vulnerability severity in the equation above.

Various examples may possibly be described by one or more of the following features in the following numbered clauses:

Clause 1. A computer implemented method for generating a machine learning system from software packages, wherein the software packages comprise package specific security vulnerability metadata, the method comprising: receiving a specification of the machine learning system, wherein the specification comprises security vulnerability constraints; selecting the software packages from a collection of software packages using the specification and by comparing the package specific security vulnerability metadata to the security vulnerability constraints; generating the machine learning system using the selected software packages; and training the machine learning system using the specification.

Clause 2. The computer implemented method of clause 1, wherein the method further comprises calculating a current security compliance metric of the machine learning system from the package specific security vulnerability metadata of the selected software packages.

Clause 3. The computer implemented method of clause 2, wherein the package specific security vulnerability metadata comprises a package specific security vulnerability score and a package specific penalty score, and wherein the current security compliance metric of the machine learning system is a sum of the package specific security vulnerability score multiplied by the package specific penalty score summed for the selected software packages.

Clause 4. The computer implemented method of clause 2 or 3, wherein the method further comprises: receiving a security patch for one of the software packages, calculating a projected security compliance metric, and providing a signal if a difference between the projected security compliance metric and the current security compliance metric is below a predetermined threshold.

Clause 5. The computer implemented method of clause 4, wherein the signal causes any one of the following: providing a warning signal, providing a notification, blocking installation of the security patch, and combinations thereof.

Clause 6. The computer implemented method of clause 4 or 5, wherein the method further comprises installing the security patch if the difference between the projected security compliance metric and the current security compliance metric is above the predetermined threshold.

Clause 7. The computer implemented method of any one of clauses 2 through 6, wherein the method further comprises: receiving an updated software package, wherein the software packages comprise the updated software package; integrating the updated software package into the machine learning system; retraining the machine learning system after integration of the updated software package; and recalculating the current security compliance metric of the machine learning system.

Clause 8. The computer implemented method of any one of clauses 2 through 7, wherein the software packages further comprise at least one machine learning metric, wherein the method further comprises constructing an objective function from the at least one machine learning metric and the current security compliance metric, wherein training the machine learning system comprises optimizing the objective function.

Clause 9. The computer implemented method of clause 8, wherein the objective function is a difference between the at least one machine learning metric and the current security compliance metric.

Clause 10. The computer implemented method of any one of the preceding clauses, wherein the method further comprises determining the package specific security vulnerability metadata using a security vulnerability scan module.

Clause 11. The computer implemented method of any one of the preceding clauses wherein the specification of the machine learning system further comprises any one of the following: training data, input specification of the machine learning system, output specification of the machine learning system, and combinations thereof.

Clause 12. The computer implemented method of any one of the preceding clauses, wherein selecting software packages using the specification and by comparing the package specific security vulnerability metadata to the security vulnerability constraints is a filtering process.

Clause 13. The computer implemented method of any one of the preceding clauses, wherein the security vulnerability constraints comprise any one of the following: a severity of allowed security vulnerabilities, a number of vulnerabilities, and a combination thereof.

Clause 14. The computer implemented method of any one of the preceding clauses, wherein the software packages comprise any one of the following: artificial intelligence models, an estimator model, a predictor model, executable files, executable scripts, binary files, and combinations thereof.

Clause 15. A computer program product for generating a machine learning system from software packages, wherein the software packages comprise package specific security vulnerability metadata, the computer program product comprising: one or more computer readable storage media, and program instructions collectively stored on one or more computer readable storage media, the program instructions comprising: program instructions to receive a specification of the machine learning system, wherein the specification comprises security vulnerability constraints; program instructions to select the software packages from a collection of software packages using the specification and by comparing the package specific security vulnerability metadata to the security vulnerability constraints; program instructions to generate the machine learning system using the selected software packages; and program instructions to train the machine learning system using the specification.

Clause 16. A computer system comprising: one or more computer processors, one or more computer readable storage media, and program instructions collectively stored on the one or more computer readable storage media for execution by at least one of the one or more computer processors, the program instructions comprising: program instructions to receive a specification of a machine learning system, wherein the specification comprises security vulnerability constraints; program instructions to select software packages from a collection of software packages, wherein the software packages comprise package specific security vulnerability metadata, wherein the software packages are selected using the specification and by comparing the package specific security vulnerability metadata to the security vulnerability constraints; program instructions to generate the machine learning system using the selected software packages; and program instructions to train the machine learning system using the specification.

Clause 17. The computer system of clause 16, further comprising program instructions, collectively stored on the one or more computer readable storage media for execution by at least one of the one or more computer processors, to calculate a current security compliance metric of the machine learning system from the package specific security vulnerability metadata of the selected software packages.

Clause 18. The computer system of clause 17, wherein the package specific security vulnerability metadata comprises a package specific security vulnerability score and a package specific penalty score, and wherein the current security compliance metric of the machine learning system is a sum of the package specific security vulnerability score multiplied by the package specific penalty score summed for the selected software packages.

Clause 19. The computer system of clause 17 or 18, further comprising: program instructions, collectively stored on the one or more computer readable storage media for execution by at least one of the one or more computer processors, to receive a security patch for one of the software packages; program instructions, collectively stored on the one or more computer readable storage media for execution by at least one of the one or more computer processors, to calculate a projected security compliance metric; and program instructions, collectively stored on the one or more computer readable storage media for execution by at least one of the one or more computer processors, to provide a signal if a difference between the projected security compliance metric and the current security compliance metric is below a predetermined threshold.

Clause 20. The computer system of clause 19, wherein the signal causes any one of the following: providing a warning signal, provide a notification, blocking installation of the security patch, and combinations thereof.

What is claimed is:

1. A computer implemented method for generating a machine learning system from software packages, wherein the software packages comprise package specific security vulnerability metadata, the method comprising:
receiving a specification of the machine learning system, wherein the specification comprises security vulnerability constraints;
selecting the software packages from a collection of software packages using the specification and by comparing the package specific security vulnerability metadata to the security vulnerability constraints;
generating the machine learning system using the selected software packages; and
training the machine learning system using the specification.

2. The computer implemented method of claim 1, wherein the method further comprises calculating a current security compliance metric of the machine learning system from the package specific security vulnerability metadata of the selected software packages.

3. The computer implemented method of claim 2, wherein the package specific security vulnerability metadata comprises a package specific security vulnerability score and a package specific penalty score, and wherein the current security compliance metric of the machine learning system is a sum of the package specific security vulnerability score multiplied by the package specific penalty score summed for the selected software packages.

4. The computer implemented method of claim 2, wherein the method further comprises:
receiving a security patch for one of the software packages;
calculating a projected security compliance metric; and
providing a signal responsive to a difference between the projected security compliance metric and the current security compliance metric being below a predetermined threshold.

5. The computer implemented method of claim 4, wherein the signal causes a selection from the group consisting of: providing a warning signal, providing a notification, and blocking installation of the security patch.

6. The computer implemented method of claim 4, wherein the method further comprises installing the security patch responsive to the difference between the projected security compliance metric and the current security compliance metric being above the predetermined threshold.

7. The computer implemented method of claim 2, wherein the method further comprises:
receiving an updated software package, wherein the software packages comprise the updated software package;
integrating the updated software package into the machine learning system;
retraining the machine learning system after integration of the updated software package; and
recalculating the current security compliance metric of the machine learning system.

8. The computer implemented method of claim 2, wherein the software packages further comprise at least one machine learning metric, wherein the method further comprises constructing an objective function from the at least one machine learning metric and the current security compliance metric, wherein training the machine learning system comprises optimizing the objective function.

9. The computer implemented method of claim 8, wherein the objective function is a difference between the at least one machine learning metric and the current security compliance metric.

10. The computer implemented method of claim 1, wherein the method further comprises determining the package specific security vulnerability metadata using a security vulnerability scan module.

11. The computer implemented method of claim 1, wherein the specification of the machine learning system further comprises a selection from the group consisting of: training data, input specification of the machine learning system, and output specification of the machine learning system.

12. The computer implemented method of claim 1, wherein selecting software packages using the specification and by comparing the package specific security vulnerability metadata to the security vulnerability constraints is a filtering process.

13. The computer implemented method of claim 1, wherein the security vulnerability constraints comprise a selection from the group consisting of: a severity of allowed security vulnerabilities and a number of vulnerabilities.

14. The computer implemented method of claim 1, wherein the software packages comprise a selection from the group consisting of: an artificial intelligence model, an estimator model, a predictor model, an executable file, an executable script, and a binary file.

15. A computer program product for generating a machine learning system from software packages, wherein the software packages comprise package specific security vulnerability metadata, the computer program product comprising:
one or more computer readable storage media, and program instructions collectively stored on one or more computer readable storage media, the program instructions comprising:
program instructions to receive a specification of the machine learning system, wherein the specification comprises security vulnerability constraints;
program instructions to select the software packages from a collection of software packages using the specification and by comparing the package specific security vulnerability metadata to the security vulnerability constraints;
program instructions to generate the machine learning system using the selected software packages; and
program instructions to train the machine learning system using the specification.

16. A computer system comprising:
one or more computer processors, one or more computer readable storage media, and program instructions collectively stored on the one or more computer readable storage media for execution by at least one of the one or more computer processors, the program instructions comprising:
program instructions to receive a specification of a machine learning system, wherein the specification comprises security vulnerability constraints;
program instructions to select software packages from a collection of software packages, wherein the software packages comprise package specific security vulnerability metadata, wherein the software packages are selected using the specification and by comparing the package specific security vulnerability metadata to the security vulnerability constraints;
program instructions to generate the machine learning system using the selected software packages; and
program instructions to train the machine learning system using the specification.

17. The computer system of claim 16, further comprising program instructions, collectively stored on the one or more computer readable storage media for execution by at least one of the one or more computer processors, to calculate a current security compliance metric of the machine learning system from the package specific security vulnerability metadata of the selected software packages.

18. The computer system of claim 17, wherein the package specific security vulnerability metadata comprises a package specific security vulnerability score and a package specific penalty score, and wherein the current security compliance metric of the machine learning system is a sum of the package specific security vulnerability score multiplied by the package specific penalty score summed for the selected software packages.

19. The computer system of claim 17 or 18, further comprising:
program instructions, collectively stored on the one or more computer readable storage media for execution by at least one of the one or more computer processors, to receive a security patch for one of the software packages;
program instructions, collectively stored on the one or more computer readable storage media for execution by at least one of the one or more computer processors, to calculate a projected security compliance metric; and
program instructions, collectively stored on the one or more computer readable storage media for execution by at least one of the one or more computer processors, to provide a signal if a difference between the projected security compliance metric and the current security compliance metric is below a predetermined threshold.

20. The computer system of claim 19, wherein the signal causes a selection from the group consisting of: providing a warning signal, provide a notification, and blocking installation of the security patch.
